(19) United States
(12) Patent Application Publication
(10) Pub. No.: US 2026/0302317 A1
(43) Pub. Date: Oct. 1, 2026

(54) METHOD FOR MANUFACTURING BATTERY

(71) Applicant: HONDA MOTOR CO., LTD., Tokyo (JP)

(72) Inventors: Hirokazu WATANABE, Saitama (JP); Hidemasa Usui, Saitama (JP)

(73) Assignee: HONDA MOTOR CO., LTD., Tokyo (JP)

(21) Appl. No.: 19/630,473

(22) Filed: Mar. 27, 2026

(30) Foreign Application Priority Data
Mar. 28, 2025 (JP) 2025-055982

(51) Int. Cl. H01M 10/04; H01M 4/38; H01M 4/02

(52) U.S. Cl. CPC H01M 10/0468; H01M 4/382; H01M 4/386; H01M 2004/027

(57) ABSTRACT

A method for manufacturing a battery includes: compressing the first laminate of the first assembly, supporting one of the first plates, and pressing other of the first plates by a first pressing member; and overlapping one of the second plates with the other of the first plates to stack the second assembly on the first assembly, and the first pressing member is fitted into an accommodating recess provided in a mating surface of the other of the first plates, and the first pressing member partially protrudes from the mating surface of the other of the first plates, and when the second assembly is stacked on the first assembly, a protruding portion of the first pressing member protruding from the mating surface of the other of the first plates is fitted into an engagement recess provided in a mating surface of the one of the second plates.

This application is based on and claims priority under 35 USC 119 from Japanese Patent Application No. 2025-055982 filed on Mar. 28, 2025.

### TECHNICAL FIELD

The present invention relates to a method for manufacturing a battery.

### BACKGROUND ART

In recent years, researches and developments have been conducted on a secondary battery which contributes to improvement in energy efficiency in order to allow more people to have access to affordable, reliable, sustainable and advanced energy.

A battery module manufacturing method described in Patent Literature 1 is a method for manufacturing a battery module including a plurality of battery laminates, an intermediate plate, a pair of end plates, and a restraining band. In the manufacturing method, a part of the battery laminates are disposed between one of the end plates and the intermediate plate. An interval between the one end plate and the intermediate plate is narrowed, and the battery laminates disposed therebetween are compressed. Further, the remaining battery laminates are disposed between the other end plate and the intermediate plate.

In a battery pack manufacturing method described in Patent Literature 2, all battery cells constituting a battery pack are divided into two sets. In each of the sets, a plurality of battery cells are laminated with separators each interposed between two adjacent battery cells, and a laminate of the battery cells and the separators is compressed.

In a method for manufacturing a battery pack described in Patent Literature 3, a first end plate, a plurality of battery cells, and a second end plate are laminated in this order to form a battery stack. The battery stack is compressed in a laminating direction by a pressurizing jig inserted into the first end plate and the second end plate, and is accommodated in a case. Thereafter, the pressurizing jig is removed from the first end plate and the second end plate.

Patent Literature 1: JP7070381B

Patent Literature 2: JP2023-116062A

Patent Literature 3: JP2024-081372A

### SUMMARY OF INVENTION

For example, in a battery to be mounted on an electric vehicle such as an electric automobile, the number of laminated cells tends to increase in response to a request for a large capacity and/or a high voltage of the battery. When a laminate of the cells is pressurized, as the number of laminated cells increases, the cells in an intermediate portion in the laminating direction are likely to be displaced in a direction perpendicular to the laminating direction. An object of the present invention is to improve assemblability of a battery.

An aspect of the present invention is a method for manufacturing a battery in which a plurality of cushioning members and a plurality of cells each disposed between adjacent two of the cushioning members are laminated, the battery including:

a first assembly that includes

a first laminate including one or more of the cells and a plurality of the cushioning members, and

a pair of first plates configured to compressively sandwich the first laminate in a laminating direction, and

a second assembly that includes

a second laminate including one or more of the cells and a plurality of the cushioning members, and

a pair of second plates configured to compressively sandwich the second laminate in the laminating direction, the method including:

compressing the first laminate of the first assembly, supporting one of the first plates, and pressing the other of the first plates by a first pressing member; and

overlapping one of the second plates with the other first plate to stack the second assembly on the first assembly, in which

the first pressing member is fitted into an accommodating recess provided in a mating surface of the other first plate, and the first pressing member partially protrudes from the mating surface of the other first plate, and

when the second assembly is stacked on the first assembly, a protruding portion of the first pressing member protruding from the mating surface of the other first plate is fitted into an engagement recess provided in a mating surface of the one second plate.

According to the present invention, assemblability of the battery can be improved.

### BRIEF DESCRIPTION OF DRAWINGS

FIG. 1 is a front view schematically showing an example of a battery for illustrating an embodiment of the present invention.

FIG. 2 sequentially shows a method for manufacturing the battery of FIG. 1.

FIG. 3 sequentially shows the method for manufacturing the battery of FIG. 1.

FIG. 4 sequentially shows the method for manufacturing the battery of FIG. 1.

FIG. 5 sequentially shows the method for manufacturing the battery of FIG. 1.

FIG. 6 sequentially shows the method for manufacturing the battery of FIG. 1.

FIG. 7 is a front view showing a modification of the battery of FIG. 1.

FIG. 8 sequentially shows a method for manufacturing the battery of FIG. 7.

FIG. 9 sequentially shows the method for manufacturing the battery of FIG. 7.

FIG. 10 sequentially shows the method for manufacturing the battery of FIG. 7.

FIG. 11 sequentially shows the method for manufacturing the battery of FIG. 7.

### DESCRIPTION OF EMBODIMENTS

An example of a battery and a method for manufacturing the battery, which illustrate an embodiment of the present invention will be described with reference to the accompanying drawings.

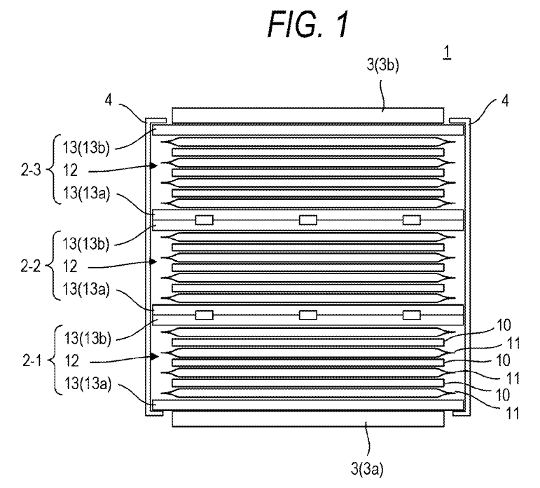

A battery 1 shown in FIG. 1 includes a plurality of cells 10 and a plurality of cushioning members 11. The cells 10 and the cushioning members 11 are flat or planar, and are laminated in a thickness direction. Each of the cells 10 is sandwiched between two adjacent cushioning members 11.

The plurality of cells 10 and the plurality of cushioning members 11 are divided into a plurality of sets, and each of the sets includes one or more cells 10 and a plurality of cushioning members 11, and further includes a pair of plates 13 that compress and sandwich a laminate 12 of the cells 10 and the cushioning members 11 in a laminating direction. A pair of the plates 13 and the laminate 12 sandwiched between the pair of plates 13 constitute one assembly. The battery 1 shown in FIG. 1 includes three assemblies, that is, a first assembly 2-1, a second assembly 2-2, and a third assembly 2-3. The number of assemblies constituting the battery 1 is not limited to three, and may be two or four or more.

The first assembly 2-1, the second assembly 2-2, and the third assembly 2-3 are stacked in this order with the laminating directions of the laminates 12 of the assemblies aligned. Further, the battery 1 includes a pair of end plates 3 that sandwich the first assembly 2-1, the second assembly 2-2, and the third assembly 2-3 in the laminating direction, and frames 4 that fix the stacked first assembly 2-1, second assembly 2-2, and third assembly 2-3. The frames 4 restrain one plate 13 of the first assembly 2-1 and one plate 13 of the third assembly 2-3 disposed at both ends in the laminating direction.

The cell 10 is a so-called laminate cell in which a positive electrode, a negative electrode, a separator, and an electrolyte are sealed in a laminate film pack. In general, as compared with a can cell in which a material of the positive electrode or the like is sealed in a cylindrical or rectangular metal container, the laminate cell is high in energy density per volume and excellent in heat dissipation.

The cell 10 may be a lithium-ion battery or a nickel-hydrogen battery using a liquid electrolyte, or may be an all-solid-state battery using a solid electrolyte. In the all-solid-state battery, the solid electrolyte also serves as the separator. In general, as compared with a lithium-ion battery or the like using a liquid electrolyte, the all-solid-state battery is excellent in temperature resistance and has a long life.

In either a cell using the liquid electrolyte or a cell using the solid electrolyte, a material having an excellent energy density but a large expansion amount, such as metallic lithium, an alloy containing metallic lithium, or silicon (Si), may be used for the negative electrode. For example, on a surface of the negative electrode made of the metallic lithium or the like, lithium is deposited due to repeated charging and discharging. When there is a variation in an in-plane pressure distribution of the cell 10, precipitation of lithium may be biased. The biased precipitation of lithium promotes the precipitated lithium to grow into a protrusion shape, which may reach the positive electrode to cause a short circuit. Therefore, it is required to uniformly pressurize each in-plane location of the cell 10 with an appropriate load.

Further, in the cell using the solid electrolyte, it is important to densify the solid electrolyte and increase adhesion between the electrodes and the solid electrolyte in order to smooth movement of ions between the electrodes. Therefore, it is required to uniformly pressurize each in-plane location of the cell 10 with an appropriate load.

The cushioning member 11 is a pouch in which a fluid such as a gas or a liquid is sealed in a bag-shaped insulating packaging material. Based on isotropy of a fluid pressure inside the cushioning member 11, a load acting on each in-plane location of the cell 10 sandwiched between two adjacent cushioning members 11 is equalized. The cushioning member 11 is not limited to the above-described pouch as long as the cushioning member 11 has cushioning properties and pressure equalization properties.

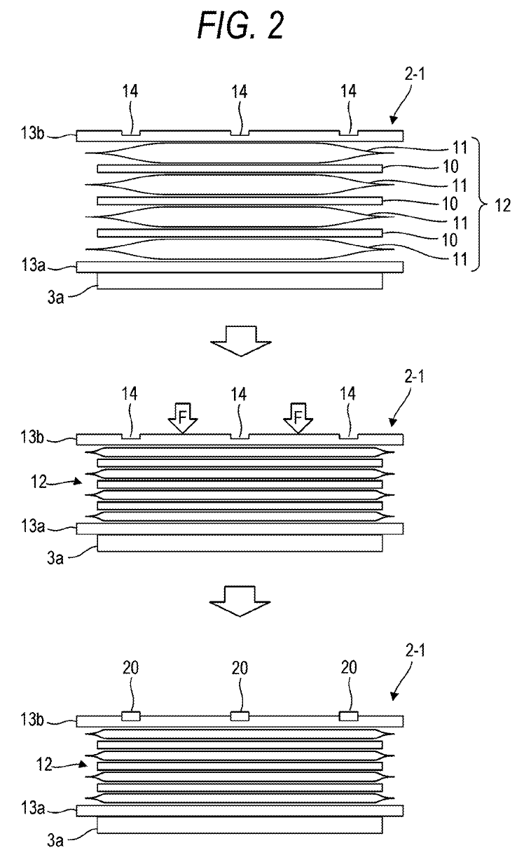

An example of a method for manufacturing the battery 1 will be described with reference to FIGS. 2-6. Hereinafter, a stacking direction of the cells 10 and the cushioning members 11 in the laminate 12 of each assembly and a laminating direction of the first to third assemblies will be described as an upper-lower direction for convenience.

As shown in FIG. 2, the laminate 12 and the pair of plates 13 constituting the first assembly 2-1 are placed on a lower end plate 3a of the pair of end plates 3. At this time, the laminate 12 is not compressed.

Next, the lower end plate 3a and the first assembly 2-1 are installed in a compression device. A lower plate 13a of the first assembly 2-1 is supported by the compression device with the end plate 3 interposed therebetween, and a load in the upper-lower direction is applied to an upper plate 13b on an opposite side. Accordingly, the laminate 12 of the first assembly 2-1 is compressed in the laminating direction.

Then, the upper plate 13b is pressed by first pressing members 20 in a state where the laminate 12 is compressed. Accordingly, the laminate 12 is maintained in a compressed state. In a pair of surfaces of the upper plate 13b, an upper surface opposite to a lower surface in contact with the laminate 12 is provided with accommodating recesses 14. Each of the accommodating recesses 14 extends in one direction (X direction) in the upper surface of the upper plate 13b, and at least one end in an extending direction of the accommodating recess 14 is open to one side surface of the upper plate 13b. The first pressing members 20 are fitted into the accommodating recesses 14 respectively, and each of the first pressing members 20 partially protrudes from the upper surface of the upper plate 13b.

In the example shown in FIG. 2, three accommodating recesses 14 are provided in the upper surface of the upper plate 13b. The three accommodating recesses 14 are provided in parallel to one another and are disposed at intervals in a direction (Y direction) intersecting the extending direction (X direction) thereof. The first pressing members 20 are fitted into the three accommodating recesses 14, respectively. The number and arrangement of the accommodating recesses 14 and the first pressing members 20 are appropriately set such that each in-plane location intersecting the laminating direction of the laminate 12 can be pressed substantially uniformly.

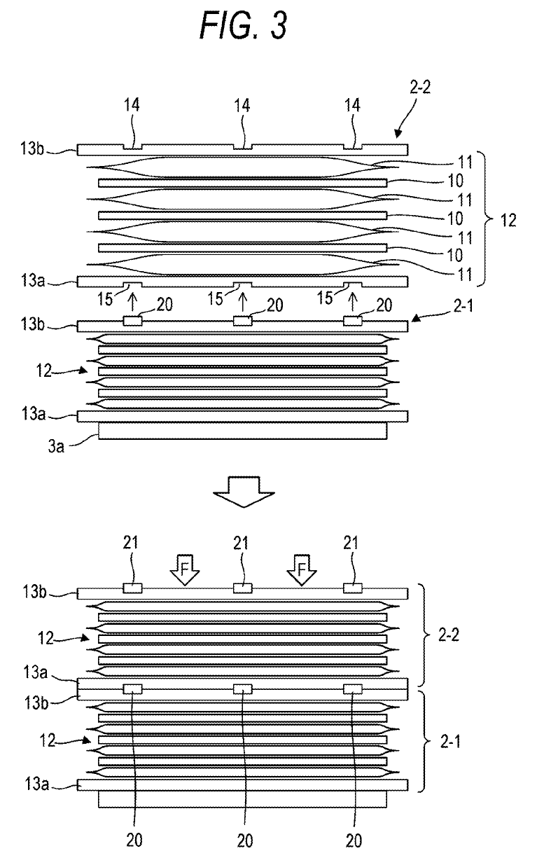

Next, as shown in FIG. 3, the second assembly 2-2 is stacked on the first assembly 2-1. The lower plate 13a of the second assembly 2-2 is overlapped with the upper plate 13b of the first assembly 2-1. A mating surface of the lower plate 13a of the second assembly 2-2 is provided with engagement recesses 15. Each of the engagement recesses 15 extends in one direction (X direction) in the mating surface of the lower plate 13a, and at least one end in an extending direction of the engagement recess 15 is open to one side surface of the lower plate 13a. Each of the engagement recesses 15 is combined with a corresponding one of the accommodating recesses 14 provided in the upper plate 13b of the first assembly 2-1 to form a hole extending in the extending direction thereof.

Similar to the accommodating recesses 14 in the upper plate 13b of the first assembly 2-1, three engagement recesses 15 are provided in the mating surface of the lower plate 13a of the second assembly 2-2. The three engagement recesses 15 are provided in parallel to one another and are disposed at intervals in the direction (Y direction) intersecting the extending direction (X direction) thereof.

When the second assembly 2-2 is stacked on the first assembly 2-1, protruding portions of the first pressing members 20 protruding from a mating surface of the upper plate 13b of the first assembly 2-1 are respectively fitted into the engagement recesses 15 provided in the mating surface of the lower plate 13a of the second assembly 2-2. Accordingly, the second assembly 2-2 is positioned with respect to the first assembly 2-1.

Then, a load in the upper-lower direction is applied to the upper plate 13b of the second assembly 2-2. Accordingly, the laminate 12 of the second assembly 2-2 is compressed in the laminating direction. Then, in a state where the laminate 12 of the second assembly 2-2 is compressed, the upper plate 13b of the second assembly 2-2 is pressed by second pressing members 21. Accordingly, the laminate 12 of the second assembly 2-2 is maintained in a compressed state.

Assuming that the number of cells 10 and the number of cushioning members 11 constituting the laminate 12 of the second assembly 2-2 is the same as the number of cells 10 and the number of cushioning members 11 constituting the laminate 12 of the first assembly 2-1, the load when compressing the laminate 12 of the second assembly 2-2 may be a load the same as the load when compressing the laminate 12 of the first assembly 2-1, or may be set to a load larger than the load when compressing the laminate 12 of the first assembly 2-1 considering that the laminate 12 of the first assembly 2-1 is also compressed to some extent.

An upper surface of the upper plate 13b of the second assembly 2-2 is provided with the accommodating recesses 14. Each of the accommodating recesses 14 extends in one direction (X direction) in an upper surface of the upper plate 13b, and at least one end in an extending direction of the accommodating recess 14 is open to one side surface of the upper plate 13b. The second pressing members 21 are fitted into the accommodating recesses 14, and each of the second pressing members 21 partially protrudes from the upper surface of the upper plate 13b.

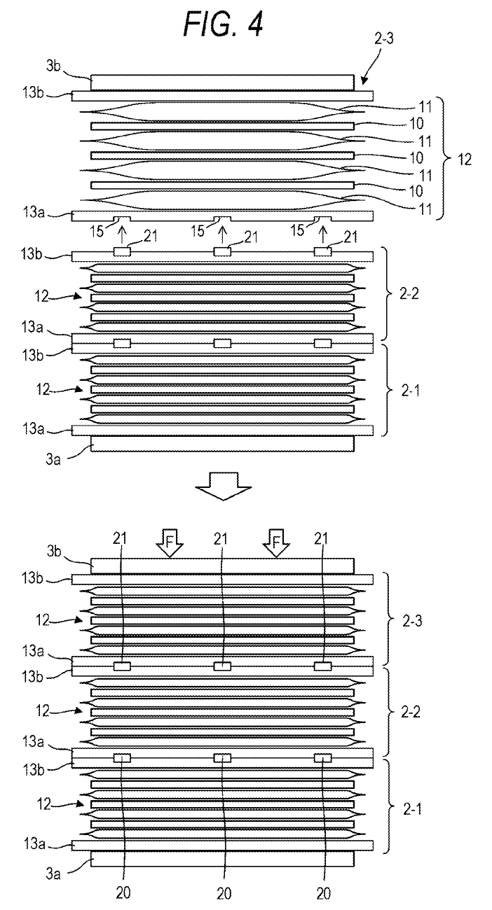

Next, as shown in FIG. 4, the third assembly 2-3 is stacked on the second assembly 2-2. Further, an upper end plate 3b is stacked on the upper plate 13b of the third assembly 2-3. The lower plate 13a of the third assembly 2-3 is overlapped with the upper plate 13b of the second assembly 2-2. The mating surface of the lower plate 13a of the third assembly 2-3 is provided with the engagement recesses 15. Each of the engagement recesses 15 extends in one direction (X direction) in the mating surface of the lower plate 13a, and at least one end in the extending direction of the engagement recess 15 is open to one side surface of the lower plate 13a. Each of the engagement recesses 15 is combined with a corresponding one of the accommodating recesses 14 provided in the upper plate 13b of the second assembly 2-2 to form a hole extending in the extending direction thereof.

Similar to the accommodating recesses 14 in the upper plate 13b of the second assembly 2-2, three engagement recesses 15 are provided in the mating surface of the lower plate 13a of the third assembly 2-3. The three engagement recesses 15 are provided in parallel to one another and are disposed at intervals in the direction (Y direction) intersecting the extending direction (X direction) thereof.

When the third assembly 2-3 is stacked on the second assembly 2-2, protruding portions of the second pressing members 21 protruding from the mating surface of the upper plate 13b of the second assembly 2-2 are respectively fitted into the engagement recesses 15 provided in the mating surface of the lower plate 13a of the third assembly 2-3. Accordingly, the third assembly 2-3 is positioned with respect to the second assembly 2-2.

Then, a load in the upper-lower direction is applied to the upper end plate 3b. Accordingly, the laminate 12 of the third assembly 2-3 is compressed in the laminating direction.

Assuming that the number of cells 10 and the number of cushioning members 11 constituting the laminate 12 of the third assembly 2-3 is the same as the number of cells 10 and the number of cushioning members 11 constituting the laminate 12 of the first assembly 2-1 or the number of cells 10 and the number of cushioning members 11 constituting the laminate 12 of the second assembly 2-2, the load when compressing the laminate 12 of the third assembly 2-3 may be a load the same as the load when compressing the laminate 12 of the first assembly 2-1 or the load when compressing the laminate 12 of the second assembly 2-2, but may be set to a load larger than the load when compressing the laminate 12 of the first assembly 2-1 or the load when compressing the laminate 12 of the second assembly 2-2 considering that the laminate 12 of the first assembly 2-1 and the laminate 12 of the second assembly 2-2 are also compressed to some extent.

A process of stacking the third assembly 2-3 on the first assembly 2-1 and the second assembly 2-2 is basically the same as a process of stacking the second assembly 2-2 shown in FIG. 3 on the first assembly 2-1 when the first assembly 2-1 and the second assembly 2-2 are regarded as one assembly. It can be said that the second assembly 2-2 is pressed by the second pressing members 21, whereas the third assembly 2-3 is pressed by the compression device with the upper end plate 3b interposed therebetween.

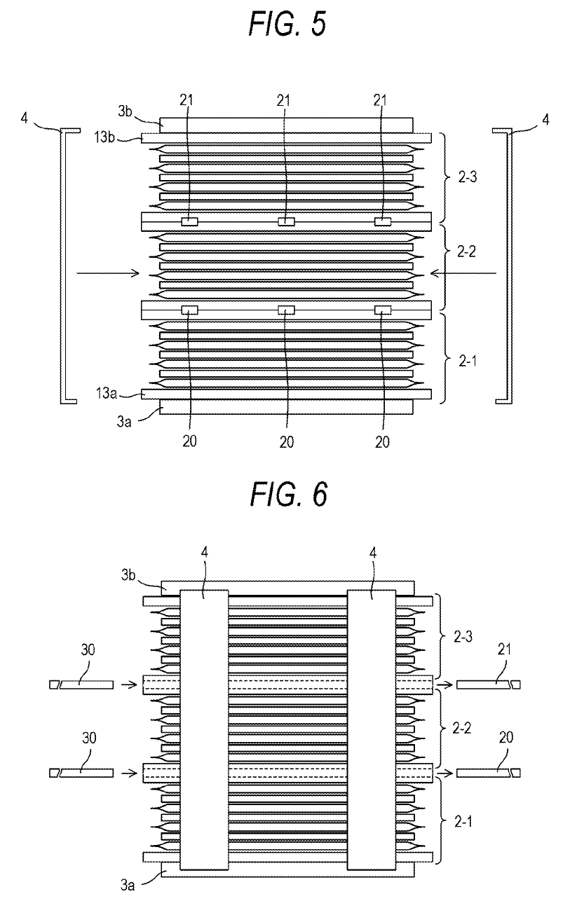

Next, as shown in FIG. 5, the frames 4 are assembled to the lower plate 13a of the first assembly 2-1 and the upper plate 13b of the third assembly 2-3 in a state where the load in the upper-lower direction is applied to the upper end plate 3b and the laminates 12 of the first assembly 2-1, the second assembly 2-2, and the third assembly 2-3 are compressed. The lower plate 13a of the first assembly 2-1 and the upper plate 13b of the third assembly 2-3 are restrained by the frames 4, and an interval therebetween is fixed. After the frames 4 are assembled, the load applied to the upper end plate 3b is removed.

Then, as shown in FIG. 6, the first pressing members 20 pressing the upper plate 13b of the first assembly 2-1 and the second pressing members 21 pressing the upper plate 13b of the second assembly 2-2 are removed in the extending direction (X direction) of the accommodating recess 14 and the engagement recess 15.

In a method for manufacturing the battery 1 shown in FIGS. 2-6, the first assembly 2-1, the second assembly 2-2, and the third assembly 2-3 are sequentially stacked, and each time one assembly is stacked, the laminate 12 of the assembly is compressed. The number of cells 10 and the number of cushioning members 11 provided in the laminate 12 of each assembly are smaller than those of all the cells 10 and the cushioning members 11 constituting the battery 1, and the laminate 12 before the compression is reduced in height. Accordingly, the compression device can be downsized. Further, since the number of cells 10 and the number of cushioning members 11 provided in the laminate 12 of each assembly are small, a positional displacement of the cells 10 and the cushioning members 11 during compression can be prevented.

Since the first pressing members 20 engage with both of the first assembly 2-1 and the second assembly 2-2 between the both, and the second pressing members 21 engage with both of the second assembly 2-2 and the third assembly 2-3 between the both, when the first assembly 2-1, the second assembly 2-2, and the third assembly 2-3 are stacked, the positioning between two adjacent assemblies is facilitated.

Further, since the first pressing member 20 engages with both of the first assembly 2-1 and the second assembly 2-2 between the both, and the second pressing member 21 engages with both of the second assembly 2-2 and the third assembly 2-3 between the both, when the laminates 12 of the second assembly 2-2 and the third assembly 2-3 are compressed, a positional displacement between two adjacent assemblies is prevented. Accordingly, the cells 10 and the cushioning members 11 can be compressed while maintaining a state in which the cells 10 and the cushioning members 11 are aligned in the laminating direction over the entire battery 1, and the assembling of the frames 4 is facilitated.

Further, since the state in which the cells 10 and the cushioning members 11 are aligned in the laminating direction is maintained, each in-plane location intersecting the thickness direction of the cells 10 can be uniformly pressed. This is useful when the cell 10 is a cell using the solid electrolyte, and is useful when the cell 10 includes a negative electrode made of the metallic lithium or the like.

Preferably, the first pressing members 20 that press the upper plate 13b of the first assembly 2-1 and the second pressing members 21 that press the upper plate 13b of the second assembly 2-2 are aligned in the upper-lower direction. While the laminates 12 of the first assembly 2-1 and the laminate 12 of the second assembly 2-2 are maintained in the compressed state by the first pressing members 20 and the second pressing members 21, each in-plane location intersecting the laminating direction of the laminate 12 can be pressed substantially uniformly.

Preferably, fitting members 30 are inserted into spaces from which the first pressing members 20 and the second pressing members 21 are removed. The battery 1 can be reinforced by engaging the fitting members 30 with the first assembly 2-1 and the second assembly 2-2 therebetween and with the second assembly 2-2 and the third assembly 2-3 therebetween.

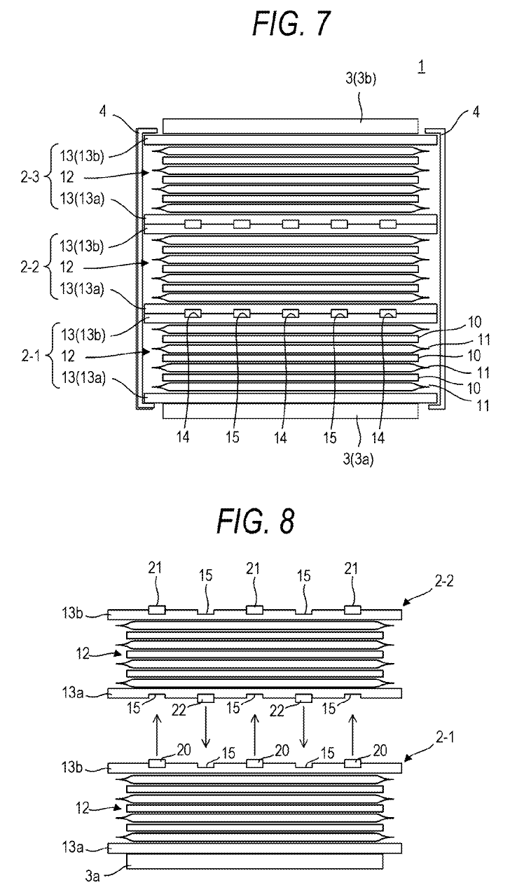

FIG. 7 shows a modification of the battery 1, in which the engagement recesses 15 are provided on each of the upper surfaces of the upper plates 13b of the first assembly 2-1 and the second assembly 2-2, and the accommodating recesses 14 are provided on the lower surfaces of the lower plates 13a of the second assembly 2-2 and the third assembly 2-3.

An example of a method for manufacturing a modification of the battery 1 shown in FIG. 7 will be described with reference to FIGS. 8-11. In the method for manufacturing the battery 1 shown in FIGS. 2-6, the first assembly 2-1, the second assembly 2-2, and the third assembly 2-3 are sequentially stacked, and each time one assembly is stacked, the laminate 12 of the assembly is compressed. Meanwhile, in the manufacturing method to be described below, the laminates 12 of the first assembly 2-1, the second assembly 2-2, and the third assembly 2-3 are individually compressed in advance.

As shown in FIG. 8, the first assembly 2-1 is placed on the lower end plate 3a. The laminate 12 of the first assembly 2-1 is compressed, the lower plate 13a of the first assembly 2-1 is supported by the compression device with the lower end plate 3a interposed therebetween, and the upper plate 13b of the first assembly 2-1 is pressed by the first pressing members 20.

Three accommodating recesses 14 are provided in the upper surface of the upper plate 13b of the first assembly 2-1, and the first pressing members 20 are respectively fitted into the three accommodating recesses 14. Two engagement recesses 15 are provided in the upper surface of the upper plate 13b, and each of the engagement recesses 15 is disposed between two adjacent accommodating recesses 14.

Then, the second assembly 2-2 is stacked on the first assembly 2-1. The laminate 12 of the second assembly 2-2 is compressed, the lower plate 13a of the second assembly 2-2 is supported by first support members 22, and the upper plate 13b of the second assembly 2-2 is pressed by the second pressing members 21.

The lower surface of the lower plate 13a of the second assembly 2-2 is provided with three engagement recesses 15. Two accommodating recesses 14 are provided in the lower surface of the lower plate 13a, and each of the accommodating recesses 14 is disposed between two adjacent engagement recesses 15. The first support members 22 are respectively fitted into the two accommodating recesses 14. Each of the first support members 22 partially protrudes from the lower surface of the lower plate 13a.

Three accommodating recesses 14 are provided in the upper surface of the upper plate 13b of the second assembly 2-2, and the second pressing members 21 are respectively fitted into the three accommodating recesses 14. Two engagement recesses 15 are provided in the upper surface of the upper plate 13b, and each of the engagement recesses 15 is disposed between two adjacent accommodating recesses 14.

When the second assembly 2-2 is stacked on the first assembly 2-1, protruding portions of the first pressing members 20 protruding from the upper surface of the upper plate 13b of the first assembly 2-1 are respectively fitted into the engagement recesses 15 provided in the lower surface of the lower plate 13a of the second assembly 2-2. Further, protruding portions of the first support members 22 protruding from the lower surface of the lower plate 13a of the second assembly 2-2 are respectively fitted into the engagement recesses 15 provided in the upper surface of the upper plate 13b of the first assembly 2-1. Accordingly, the second assembly 2-2 is positioned with respect to the first assembly 2-1.

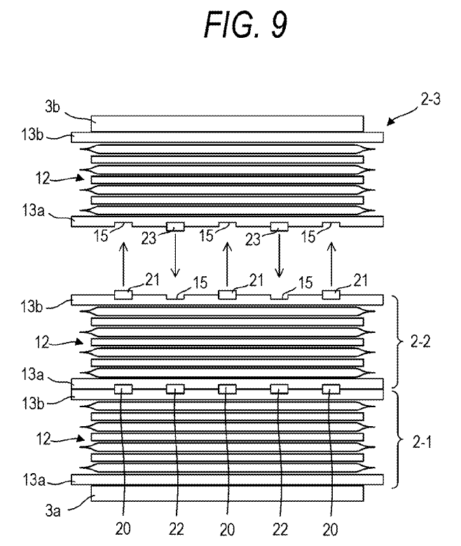

Next, as shown in FIG. 9, the third assembly 2-3 and the upper end plate 3b are stacked on the second assembly 2-2. The laminate 12 of the third assembly 2-3 is compressed, the lower plate 13a of the third assembly 2-3 is supported by second support members 23, and the upper plate 13b of the third assembly 2-3 is appropriately pressed via the upper end plate 3b.

The lower surface of the lower plate 13a of the third assembly 2-3 is provided with three engagement recesses 15. Two accommodating recesses 14 are provided in the lower surface of the lower plate 13a, and each of the accommodating recesses 14 is disposed between two adjacent engagement recesses 15. The second support members 23 are respectively fitted into the two accommodating recesses 14. Each of the second support members 23 partially protrudes from the lower surface of the lower plate 13a.

When the third assembly 2-3 is stacked on the second assembly 2-2, protruding portions of the second pressing members 21 protruding from the upper surface of the upper plate 13b of the second assembly 2-2 are respectively fitted into the engagement recesses 15 provided in the lower surface of the lower plate 13a of the third assembly 2-3. Further, protruding portions of the second support members 23 protruding from the lower surface of the lower plate 13a of the third assembly 2-3 are respectively fitted into the engagement recesses 15 provided in the upper surface of the upper plate 13b of the second assembly 2-2. Accordingly, the third assembly 2-3 is positioned with respect to the second assembly 2-2.

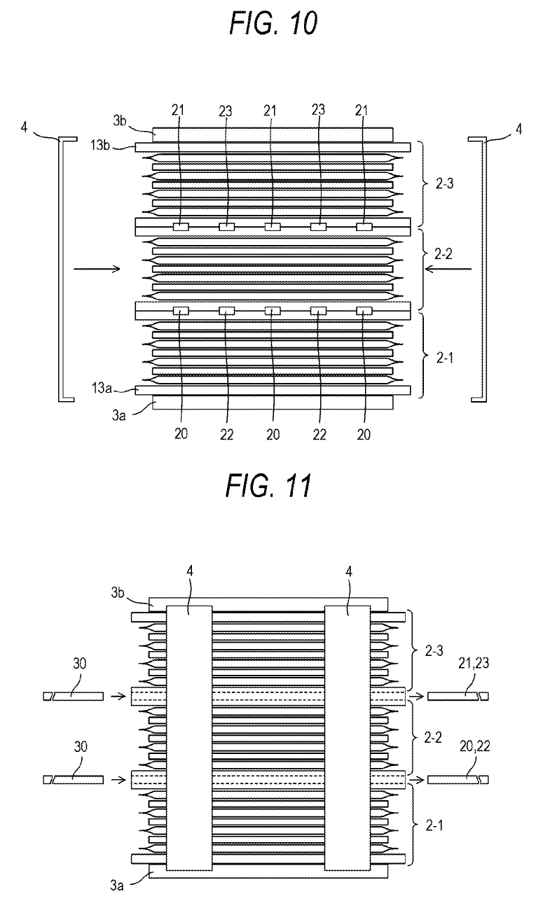

Next, as shown in FIG. 10, the frames 4 are assembled to the lower end plate 3a and the upper end plate 3b in a state where the laminates 12 of the first assembly 2-1, the second assembly 2-2, and the third assembly 2-3 are compressed. A load in the upper-lower direction may be applied to the upper end plate 3b when assembling the frames 4. The lower end plate 3a and the upper end plate 3b are restrained by the frames 4, and an interval therebetween is fixed.

Then, as shown in FIG. 11, the first pressing members 20, the second pressing members 21, the first support members 22, and the second support members 23 are removed in the extending direction (X direction) of the accommodating recess 14 and the engagement recess 15. Preferably, the fitting members 30 are inserted into spaces from which the first pressing members 20, the second pressing members 21, the first support member 22, and the second support member 23 are removed.

In the method for manufacturing the battery 1 shown in FIGS. 8-11, the laminates 12 of the first assembly 2-1, the second assembly 2-2, and the third assembly 2-3 are individually compressed in advance. The number of cells 10 and the number of cushioning members 11 provided in the laminate 12 of each assembly are smaller than those of all the cells 10 and the cushioning members 11 constituting the battery 1, and the laminate 12 before the compression is reduced in height. Accordingly, the compression device can be downsized. Further, since the number of cells 10 and the number of cushioning members 11 provided in the laminate 12 of each assembly are small, the positional displacement of the cells 10 and the cushioning members 11 during compression can be prevented.

The first pressing members 20 and the first support members 22 engage with both of the first assembly 2-1 and the second assembly 2-2 between the both, and the second pressing members 21 and the second support members 23 engage with both of the second assembly 2-2 and the third assembly 2-3 between the both, and when the first assembly 2-1, the second assembly 2-2, and the third assembly 2-3 are stacked, the positioning between two adjacent assemblies is facilitated.

Further, since the laminates 12 of the first assembly 2-1, the second assembly 2-2, and the third assembly 2-3 are individually compressed in advance, the first assembly 2-1, the second assembly 2-2, and the third assembly 2-3 may just be stacked, and the assemblability is excellent.

Further, since the state in which the cells 10 and the cushioning members 11 are aligned in the laminating direction is maintained, each in-plane location intersecting the thickness direction of the cells 10 can be uniformly pressed. This is useful when the cell 10 is a cell using the solid electrolyte, and is useful when the cell 10 includes a negative electrode made of the metallic lithium or the like.

Preferably, the first pressing members 20 that press the upper plate 13b of the first assembly 2-1 and the second pressing members 21 that press the upper plate 13b of the second assembly 2-2 are aligned in the upper-lower direction. Therefore, the first support members 22 that support the lower plate 13a of the second assembly 2-2 and the second support members 23 that support the lower plate 13a of the third assembly 2-3 are provided to be displaced from the first pressing members 20 and the second pressing members 21 aligned in the upper-lower direction, in a direction intersecting the upper-lower direction.

The embodiment of the present invention has been described above, but the present invention is not limited to the embodiment described above, and modifications, improvements, and the like can be made as appropriate. In the present description, at least the following matters are described. In the parentheses, the corresponding constituent elements and the like in the above embodiment are illustrated, but the present invention is not limited thereto.

(1) A method for manufacturing a battery (battery 1) in which a plurality of cushioning members (cushioning members 11) and a plurality of cells (cells 10) each disposed between adjacent two of the cushioning members are laminated, the battery including:

a first assembly (first assembly 2-1) that includes

a first laminate (laminate 12) including one or more of the cells and a plurality of the cushioning members, and

a pair of first plates (plates 13) configured to compressively sandwich the first laminate in a laminating direction, and

a second assembly (second assembly 2-2) that includes

a second laminate (laminate 12) including one or more of the cells and a plurality of the cushioning members, and

a pair of second plates (plates 13) configured to compressively sandwich the second laminate in the laminating direction, the method including:

compressing the first laminate of the first assembly, supporting one of the first plates (lower plate 13a), and pressing the other of the first plates (upper plate 13b) by a first pressing member (first pressing member 20); and

overlapping one of the second plates (lower plate 13a) with the other first plate (upper plate 13b) to stack the second assembly on the first assembly, in which

the first pressing member is fitted into an accommodating recess (accommodating recess 14) provided in a mating surface of the other first plate (upper plate 13b), and the first pressing member partially protrudes from the mating surface of the other first plate, and

when the second assembly is stacked on the first assembly, a protruding portion of the first pressing member protruding from the mating surface of the other first plate (upper plate 13b) is fitted into an engagement recess (engagement recess 15) provided in a mating surface of the one second plate (lower plate 13a).

According to the method for manufacturing the battery in the above (1), a compression device can be downsized. Further, a positional displacement of the cells and the cushioning members when compressing the laminates can be prevented. Further, since the pressing member engages with both of the first assembly and the second assembly between the both, positioning of the first assembly and the second assembly is facilitated. Accordingly, assemblability of the battery can be improved.

(2) The method for manufacturing the battery according to the above (1), in which

the second laminate of the second assembly to be stacked on the first assembly is not compressed, and

the other of the second plates of the second assembly stacked on the first assembly is pressurized toward the first assembly to compress the second laminate, and the other second plate is pressed.

According to the method for manufacturing the battery in the above (2), since the pressing member engages with both of the first assembly and the second assembly between the both, a positional displacement between the first assembly and the second assembly when the laminate of the second assembly is compressed can be prevented. Accordingly, the cells and the cushioning members can be compressed while maintaining a state in which the cells and the cushioning members are aligned in the laminating direction over the entire battery.

(3) The method for manufacturing the battery according to the above (2), in which

the other second plate is pressed by a second pressing member (second pressing member 21) aligned with the first pressing member in a stacking direction of the first assembly and the second assembly.

According to the method for manufacturing the battery in the above (3), while the laminates of the first assembly and the second assembly are maintained in a compressed state by the first pressing member and the second pressing member, each in-plane location intersecting the laminating direction of the laminates can be pressed substantially uniformly.

(4) The method for manufacturing the battery according to the above (2), further including:

fixing the one first plate and the other second plate to each other, and then removing the first pressing member in a direction intersecting a stacking direction of the first assembly and the second assembly.

According to the method for manufacturing the battery in the above (4), since both ends of the first assembly and the second assembly in the stacking direction are fixed, even when the pressing member is removed, the positional displacement between the first assembly and the second assembly is prevented.

(5) The method for manufacturing the battery according to the above (4), further including:

inserting a fitting member (fitting member 30), that engages with the accommodating recess of the other first plate and the engagement recess of the one second plate, into a space from which the first pressing member is removed.

According to the method for manufacturing the battery in the above (5), the battery can be reinforced.

(6) The method for manufacturing the battery according to the above (1), in which

the second laminate of the second assembly to be stacked on the first assembly is compressed, and to maintain a compressed state of the second laminate, the one second plate (lower plate 13a) is supported by a support member (first support member 22) and the other of the second plates (upper plate 13b) is pressed,

the support member is fitted into an accommodating recess (accommodating recess 14) provided in the mating surface of the one second plate, and the support member partially protrudes from the mating surface of the one second plate, and

when the second assembly is stacked on the first assembly, the protruding portion of the first pressing member (first pressing member 20) protruding from the mating surface of the other first plate (upper plate 13b) is fitted into the engagement recess (engagement recess 15) provided in the mating surface of the one second plate (lower plate 13a), and a protruding portion of the support member (first support member 22) protruding from the mating surface of the one second plate (lower plate 13a) is fitted into an engagement recess (engagement recess 15) provided in the mating surface of the other first plate (upper plate 13b).

According to the method for manufacturing the battery in the above (6), since the laminates of the first assembly and the second assembly are individually compressed in advance, the first assembly and the second assembly may just be stacked, the assemblability of the battery can be further improved.

(7) The method for manufacturing the battery according to the above (6), in which

the other second plate is pressed by a second pressing member aligned with the first pressing member in a stacking direction of the first assembly and the second assembly, and

the support member is displaced from the first pressing member and the second pressing member in a direction intersecting the stacking direction.

According to the method for manufacturing the battery in the above (7), while the laminates of the first assembly and the second assembly are maintained in the compressed state by the first pressing member and the second pressing member, each in-plane location intersecting the laminating direction of the laminates can be pressed substantially uniformly.

(8) The method for manufacturing the battery according to the above (6), further including:

fixing the one first plate and the other second plate to each other, and then removing the first pressing member and the support member in a direction intersecting a stacking direction of the first assembly and the second assembly.

According to the method for manufacturing the battery in the above (8), since both ends of the first assembly and the second assembly in the stacking direction are fixed, even when the first pressing member and the support member are removed, the positional displacement between the first assembly and the second assembly is prevented.

(9) The method for manufacturing the battery according to the above (8), further including:

inserting a fitting member, that engages with the accommodating recess of the other first plate and the engagement recess of the one second plate, into a space from which the first pressing member is removed, and/or

inserting a fitting member, that engages with the engagement recess of the other first plate and the accommodating recess of the one second plate, into a space from which the support member is removed.

According to the method for manufacturing the battery in the above (9), the battery can be reinforced.

(10) The method for manufacturing the battery according to any one of the above (1) to (9), in which

each of the cells includes a solid electrolyte.

(11) The method for manufacturing the battery according to any one of the above (1) to (9), in which

a negative electrode of each of the cells contains metallic lithium or an alloy containing metallic lithium.

(12) The method for manufacturing the battery according to any one of the above (1) to (9), in which

a negative electrode of each of the cells contains silicon.

(13) The method for manufacturing the battery according to any one of the above (1) to (9), in which

each of the cushioning members includes a fluid sealed in a bag-shaped packaging material.

### REFERENCE SIGNS LIST

1 battery
2-1 first assembly
2-2 second assembly
2-3 third assembly
3a lower end plate
3b upper end plate
4 frame
10 cell
11 cushioning member
12 laminate
13a lower plate
13b upper plate
14 accommodating recess
15 engagement recess
20 first pressing member
21 second pressing member
22 first support member
23 second support member
30 fitting member

What is claimed is:

1. A method for manufacturing a battery in which a plurality of cushioning members and a plurality of cells each disposed between adjacent two of the cushioning members are laminated, the battery including:
a first assembly that includes
a first laminate including one or more of the cells and a plurality of the cushioning members, and
a pair of first plates configured to compressively sandwich the first laminate in a laminating direction, and
a second assembly that includes
a second laminate including one or more of the cells and a plurality of the cushioning members, and
a pair of second plates configured to compressively sandwich the second laminate in the laminating direction, the method comprising:
compressing the first laminate of the first assembly, supporting one of the first plates, and pressing other of the first plates by a first pressing member; and
overlapping one of the second plates with the other of the first plates to stack the second assembly on the first assembly, wherein
the first pressing member is fitted into an accommodating recess provided in a mating surface of the other of the first plates, and the first pressing member partially protrudes from the mating surface of the other of the first plates, and
when the second assembly is stacked on the first assembly, a protruding portion of the first pressing member protruding from the mating surface of the other of the first plates is fitted into an engagement recess provided in a mating surface of the one of the second plates.

2. The method for manufacturing the battery according to claim 1, wherein
the second laminate of the second assembly to be stacked on the first assembly is not compressed, and
other of the second plates of the second assembly stacked on the first assembly is pressurized toward the first assembly to compress the second laminate, and the other of the second plates is pressed.

3. The method for manufacturing the battery according to claim 2, wherein
the other of the second plates is pressed by a second pressing member aligned with the first pressing member in a stacking direction of the first assembly and the second assembly.

4. The method for manufacturing the battery according to claim 2, further comprising:
fixing the one of the first plates and the other of the second plates to each other, and then removing the first pressing member in a direction intersecting a stacking direction of the first assembly and the second assembly.

5. The method for manufacturing the battery according to claim 4, further comprising:
inserting a fitting member, that engages with the accommodating recess of the other of the first plates and the engagement recess of the one of the second plates, into a space from which the first pressing member is removed.

6. The method for manufacturing the battery according to claim 1, wherein
the second laminate of the second assembly to be stacked on the first assembly is compressed, and to maintain a compressed state of the second laminate, the one of the second plates is supported by a support member and other of the second plates is pressed,
the support member is fitted into an accommodating recess provided in the mating surface of the one of the second plates, and the support member partially protrudes from the mating surface of the one of the second plates, and
when the second assembly is stacked on the first assembly, the protruding portion of the first pressing member protruding from the mating surface of the other of the first plates is fitted into the engagement recess provided in the mating surface of the one of the second plates, and a protruding portion of the support member protruding from the mating surface of the one of the second plates is fitted into an engagement recess provided in the mating surface of the other of the first plates.

7. The method for manufacturing the battery according to claim 6, wherein
the other of the second plates is pressed by a second pressing member aligned with the first pressing member in a stacking direction of the first assembly and the second assembly, and
the support member is displaced from the first pressing member and the second pressing member in a direction intersecting the stacking direction.

8. The method for manufacturing the battery according to claim 6, further comprising:
fixing the one of the first plates and the other of the second plates to each other, and then removing the first pressing member and the support member in a direction intersecting a stacking direction of the first assembly and the second assembly.

9. The method for manufacturing the battery according to claim 8, further comprising, at least one of:
inserting a fitting member, that engages with the accommodating recess of the other of the first plates and the engagement recess of the one of the second plates, into a space from which the first pressing member is removed; or
inserting a fitting member, that engages with the engagement recess of the other of the first plates and the accommodating recess of the one of the second plates, into a space from which the support member is removed.

10. The method for manufacturing the battery according to claim 1, wherein
each of the cells includes a solid electrolyte.

11. The method for manufacturing the battery according to claim 2, wherein
each of the cells includes a solid electrolyte.

12. The method for manufacturing the battery according to claim 3, wherein
each of the cells includes a solid electrolyte.

13. The method for manufacturing the battery according to claim 1, wherein
a negative electrode of each of the cells contains metallic lithium or an alloy containing metallic lithium.

14. The method for manufacturing the battery according to claim 2, wherein
a negative electrode of each of the cells contains metallic lithium or an alloy containing metallic lithium.

15. The method for manufacturing the battery according to claim 3, wherein
a negative electrode of each of the cells contains metallic lithium or an alloy containing metallic lithium.

16. The method for manufacturing the battery according to claim 1, wherein
a negative electrode of each of the cells contains silicon.

17. The method for manufacturing the battery according to claim 2, wherein
a negative electrode of each of the cells contains silicon.

18. The method for manufacturing the battery according to claim 3, wherein
a negative electrode of each of the cells contains silicon.

19. The method for manufacturing the battery according to claim 1, wherein
each of the cushioning members includes a fluid sealed in a packaging material.

20. The method for manufacturing the battery according to claim 2, wherein
each of the cushioning members includes a fluid sealed in a packaging material.
